(19) United States
(12) Patent Application Publication
(10) Pub. No.: US 2004/0037561 A1
(43) Pub. Date: Feb. 26, 2004

(54) Transmission of data

(76) Inventors: Kenneth Guild, Essex (GB); Michael O'Mahony, Suffolk (GB); Dimitra Simeonidou, Essex (GB); Anna Tzanakaki, Essex (GB)

Correspondence Address: NIXON & VANDERHYE, PC, 1100 N GLEBE ROAD, 8TH FLOOR, ARLINGTON, VA, 22201-4714, US

(21) Appl. No.: 10/257,540

(22) PCT Filed: Apr. 12, 2001
(86) PCT No.: PCT/GB01/01696

(30) Foreign Application Priority Data
Apr. 14, 2000 (GB) 0009143.9

(51) Int. Cl. H04J 14/02

(52) U.S. Cl. 398/79

(57) ABSTRACT

In a method of transmitting data over an optical transmission network, the data to be transmitted is divided into a plurality of data streams, each of which comprises data packets of predetermined lengths with the packet lengths of each stream differing from those of the other streams. Individual packet streams are associated on to respective wavelengths of a wavelength division multiplexed optical signal for transmission over the network.

### FIELD OF THE INVENTION

This invention relates to a method of transmitting data over an optical transmission network, as well as to such a network adapted to optimise the transmission of data.

### BACKGROUND TO THE INVENTION

Increasingly, the digital traffic on an optical network is in the form of Internet protocol (IP) packets. To meet the demands of this rapidly increasing traffic, network operators are having to deploy dense wavelength division multiplexing (DWDM) equipment, so as to upgrade the capacity of the already existing optical fibre infrastructure. Further, in order that intermediate routing nodes may also handle the increase in traffic, optical packet-switched (OPS) equipment must be introduced so that the majority of the switching functions are performed in the optical domain, without the need to convert the optical signals to electronic signals which are appropriately routed before being converted up once more to optical signals.

A known problem of optical packet-switched layers is that timing conflicts occur within the routing nodes. In an attempt to resolve such timing contentions in an all-optical network, it has been proposed to introduced fixed-length fibre delay lines, so ensuring that switching can still take place in an appropriate manner.

For the above reasons, it is known to employ in an OPS network a timeslotted regime where all user data is encapsulated into fixed-length cells. Then, in order to provide time transparency for real-time applications and also to permit efficient use of the overall transmission capacity of the network, a compromise over the cell length has to be adopted.

At the present time, web applications account for approximately 75% of all Internet traffic and generally, such applications are insensitive to packet delay variations across a network. By contrast, time-sensitive speech, audio and video Internet traffic is becoming more common and such traffic is very much more sensitive to network packet delay variations. The use of Internet Protocol version 6 (IPv6) will gradually become more widespread and the resource reservation protocols (RSVP) of IPv6 allow for better control of the quality of service (QOS). Consequently, as

Internet traffic becomes even more heterogeneous in nature, there will be a requirement for these QoS mechanisms to be fully utilised within an OPS network.

Observation of Internet protocol traffic over a network shows that the packet sizes exhibit significant modality. It is found that nearly half the packets are 40 to 44 bytes in length, 75% are less than 522 bytes in length and almost no packets are more than 1500 bytes in length. Since the transfer connection protocol (TCP) accounts for 95% of IP traffic, this modality is primarily due to the length constraints of the TOP definitions, though the upper limit of 1500 bytes results from the maximum transmission unit (MTU) size of an Ethernet-attached host.

In addition to the variable lengths of the packets, there is a large variation in the arrival times at a switching node of packets of IP traffic transmitted over an optical network. In order to reduce the probability of any given packet being lost consequent upon this variation in arrival times, it is consequently necessary to employ relatively large packet buffers at a switching node.

It is a principal aim of the present invention to enhance the transmission efficiency of an all-optical network, as well as to minimise the variation in the arrival times of transmitted packets of data.

### SUMMARY OF THE INVENTION

According to one aspect of the present invention, there is provided a method of transmitting data over an optical transmission network, comprising dividing the data to be transmitted into a plurality of data streams each of which comprises data packets of predetermined lengths with the packet lengths of each stream differing from those of the other streams, and associating the individual packet streams on to respective wavelengths of a wavelength division multiplexed optical signal for transmission over the network.

According to a second aspect of the present invention, there is provided an optical data transmission network including optical fibres for the transmission of a digital data stream, comprising means to divide the data stream into a plurality of data streams each of which comprises data packets of predetermined lengths with the packet lengths of each stream differing from those of the other streams, a wavelength-division multiplexor to assign the individual packet streams on to the respective wavelengths of a wavelength-divided optical signal, and means to supply the wavelength-division multiplexed optical signal to an optical fibre for transmission over the network.

It will be appreciated that by adopting the method of the present invention, on any given wavelength of a wavelength division multiplexed optical signal each packet may contain the maximum, or close to the maximum, possible amount of user data, so leading to high transmission efficiencies. Moreover, by employing a fixed packet-length regime, the variation in arrival times of packets at a switching node may be greatly reduced.

When the packets are received at an optical routing node, the wavelength transporting a cell may be used to identify the length of the packet, and so also the type of traffic in that packet stream. Thus, there is maintained a simple time-slotted operation for each wavelength channel, at a routing node. In this way, the head-of-line blocking, caused by large time-insensitive packets, may be removed and the optical network is able to offer a time-sensitive traffic channel with very low latency and a significantly smaller delay variations.

Though the method of this invention could otherwise be used, its prime application is in the transmission of Internet protocol data packets of variable length. Then, the division of the data packets into the plurality of data streams is performed on the basis of the length of those packets to produce, in each stream, fixed length packets. Further, the number of wavelengths selected for the transmission of the data packets should be such that there is an optimum utilisation of the traffic capacity across the wavelength-divided optical signal.

It will be appreciated that the method of the present invention is particularly suitable for the transmission of traffic including time-sensitive data or real-time signals such as speech, audio and video traffic. Thus, the transmission method advantageously can be employed in heterogeneous traffic suitable for deployment on IPv6 and utilising full QoS mechanisms.

### BRIEF DESCRIPTION OF THE DRAWINGS

An example of the present invention will now be described in detail with reference to the accompanying drawings, in which:

FIG. 1 shows packet streams in both electrical and optical layers;

FIG. 2 shows a network edge switch according to an embodiment of the present invention; and,

FIG. 3 shows an optical data transmission network according to an embodiment of the present invention

### DETAILED DESCRIPTION

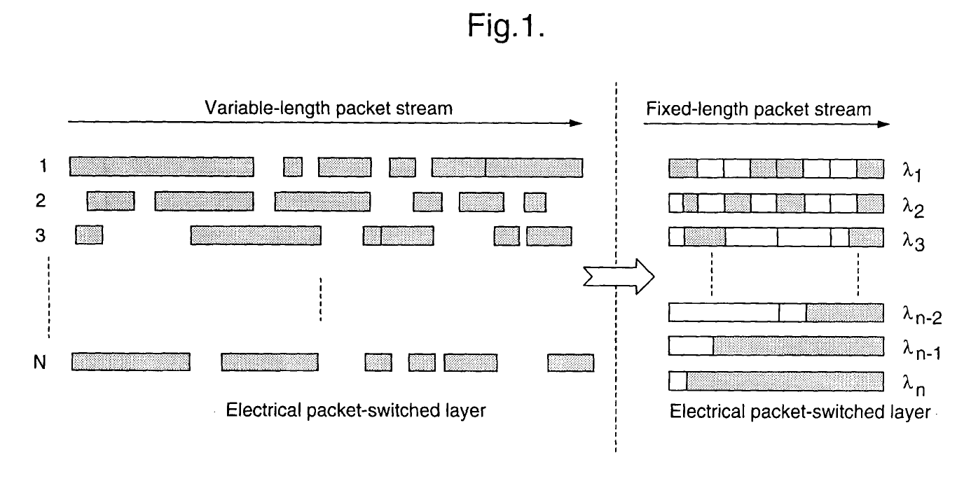

In the method of this invention, advantage is taken of the packet size modality of typical Internet traffic. The traffic is segregated into separate streams containing different length packets, which are then transmitted on different wavelengths of a wavelength-division multiplexed optical signal. This function may be performed in the network edge switches (NES) of the optical packet-switched network, such that a time-slotted packet stream is presented to the optical network. As shown in FIG. 1, in the electrical packet-switched layer, the packet traffic may consist of a number of streams 1, 2, . . . (N-1), N, each having variable length packets. These are then re-organised in the electrical/optical adaptation layer so as to consist of a number of packet streams each having fixed-length packets, as shown in the optical packet-switched layer. Those individual packet streams are assigned on to the separate wavelengths λ₁, λ₂ . . . λₙ of the optical signal transmitted over the network.

In this way, the transmitted wavelength identifies the length of a cell in a packet stream, resulting in simplification of the switching mode management. Further, the adaptation layer between the electrical and optical layers is able more efficiently to map the variable length packets on to the time-slotted optical packet-switched layer. This results in a notable reduction in the required number of optical buffers at optical routing processing points within the network.

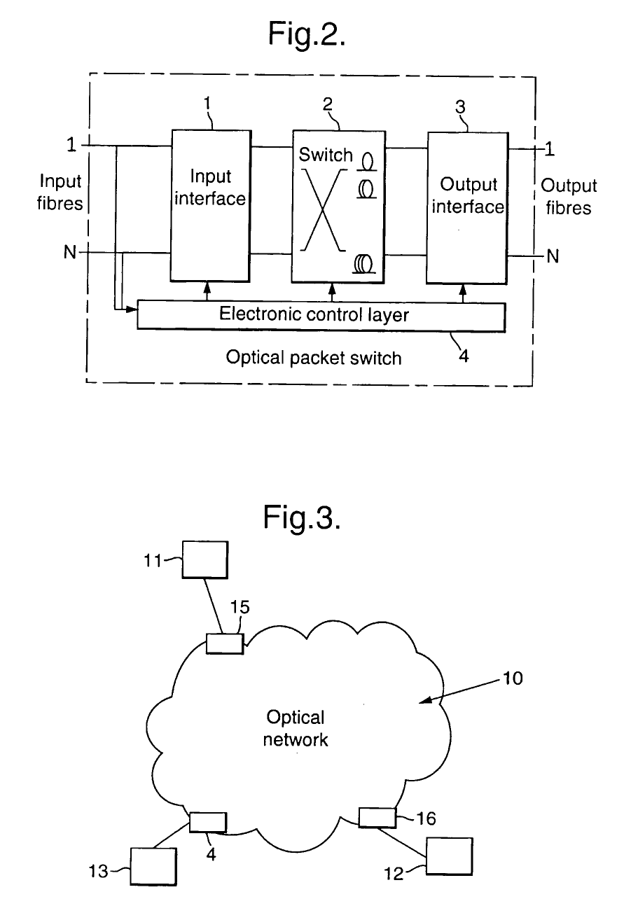

FIG. 2 shows an example of a network edge switch as mentioned above. A number of input signals, having different packet lengths, are input to an input interface 1. The input interface 1 performs coarse synchronisation and phase alignment in case of synchronous operation and also delineation (i.e. identification of the packet start and end) and header recognition of the incoming packets in case of both synchronous and asynchronous operation. The switching block 2 is responsible for the routing of the packets to the appropriate output ports and the contention resolution, while the output interface 3 is responsible for the header reinsertion, wavelength conversion (to enable the required wavelength mapping) and any regeneration that may be performed within the switching node. Each of the components of the packet switching device is controlled by an electronic control layer 4. The electronic control layer 4 is used to enable appropriate operation of the hardware associated with the three stages of the optical packet switch.

FIG. 3 shows an optical data transmission network 10. A number of end stations 11,12,13 are in communication with one another via the optical network 13 which includes a number of nodes that handle circuit switches and/or packet switched traffic. In particular, the network 10 includes a number of network edge switches 14, 15,16, as described above with reference to FIG. 2 that implement the present invention. Data to be sent from one end station to another is organised into data streams having different packet lengths at the network edge switches 14,15,16 and assigned to a particular wavelength to be carried over the optical fibres. The data is then routed and transmitted across the optical network, before being converted back to an electrical signal at the appropriate end station.

1. A method of transmitting data over an optical transmission network, comprising dividing the data to be transmitted into a plurality of data streams each of which comprises data packets of predetermined lengths with the packet lengths of each stream differing from those of the other streams, and associating the individual packet streams onto respective wavelengths of a wavelength division multiplexed optical signal for transmission over the network.

2. A method according to claim 1, wherein the data to be transmitted over the optical network comprises data packets of variable length.

3. A method according to claim 2, wherein the division of the data packets into separate streams is performed on the basis of the length of those packets so to produce, in each stream, packets of lengths falling within a predetermined range.

4. A method according to claim 3, wherein all of the packets in any one stream are of the same length.

5. A method according to any preceding claim, wherein the number of wavelengths employed for the transmission of the data packets is selected such that there is a substantially optimum utilisation of the traffic capacity across the wavelength-divided optical signal.

6. A method according to any preceding claim, wherein the data to be transmitted comprises time-sensitive data the timing of which must be maintained over the network.

7. A method according to claim 6, wherein the data to be transmitted comprises real-time signals.

8. An optical data transmission network including optical fibres for the transmission of a digital data stream, comprising means to divide the data stream into a plurality of data streams each of which comprises data packets of predetermined lengths with the packet lengths of each stream differing from those of the other streams, a wavelength-division multiplexor to assign the individual packet streams onto the respective wavelengths of a wavelength-divided optical signal, and means to supply the wavelength-division multiplexed optical signal to an optical fibre for transmission over the network.

9. An optical data transmission network as claimed in claim 8, wherein the network includes optical packet switched equipment to perform packet switching functions in the optical domain.

10. An optical data transmission network as claimed in claim 8 or claim 9, wherein the means to divide the data stream operates to divide the data stream into a sufficient number of data packet streams that the loading across the wavelength division multiplexed optical signal substantially optimises the traffic capacity of the optical signal.
